(19) United States
(12) Patent Application Publication
(10) Pub. No.: US 2013/0266743 A1
(43) Pub. Date: Oct. 10, 2013

(54) OPTICAL FILM AND METHOD FOR PRODUCING THE SAME

(71) Applicant: FUJIFILM CORPORATION, Tokyo (JP)

(72) Inventors: Jun TAKEDA, Kanagawa (JP); Takashi TAMADA, Kanagawa (JP); Taku WAKITA, Kanagawa (JP)

(73) Assignee: FUJIFILM CORPORATION, Tokyo (JP)

(21) Appl. No.: 13/845,659

(22) Filed: Mar. 18, 2013

(30) Foreign Application Priority Data
Apr. 5, 2012 (JP) 2012-086042

(51) Int. Cl. G02F 1/1333; G02B 5/30

(52) U.S. Cl. CPC G02F 1/1333; G02B 5/3041; G02B 5/30
USPC 428/1.31; 428/220; 264/2.7; 359/483.01

(57) ABSTRACT

An optical film having a thickness of from 20-60 μm, Re(550) of larger than 80-350 nm, an elastic modulus Em in a direction that is in parallel or perpendicular to one arbitrary edge of the film and provides a maximum elastic modulus of the film, and an elastic modulus Es in a direction that is perpendicular to the direction of Em, with satisfying Em/Es of 1.5-2.5; and satisfying:

$$- 0.14 ≦ \frac{log {E}_{T 10}^{′} - log {E}_{T 100}^{′}}{{T}_{10} - {T}_{100}} ≦ - 0.02$$

wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

### CROSS-REFERENCE TO RELATED APPLICATIONS

The present application claims the benefit of priority from Japanese Patent Application No. 2012-086042, filed on Apr. 5, 2012, the contents of which are herein incorporated by reference in their entirety.

### BACKGROUND OF THE INVENTION

1. Field of the Invention

The present invention relates to an optical film and a method for producing the optical film.

2. Description of the Related Art

A liquid crystal display device often has an optical film that is excellent in optical uniformity (i.e., with less optical unevenness) for compensating the contrast and the viewing angle of an image displayed thereon. In general, optical films produced by the same process have a correlation between the optical unevenness and the intrinsic birefringence, and therefore a material having a large intrinsic birefringence is liable to suffer from optical unevenness.

In recent years, IPS (in-plane switching) type and FFS (fringe field switching) type liquid crystal display devices are being spread as a professional use display device requiring high image quality and a consumer use display device that requires high image quality, due to the small changes in luminance and color depending on the viewing angle, which are derived from the homogeneous orientation of liquid crystal molecules in the liquid crystal cells.

The liquid crystal display devices are often used as a liquid crystal display device for a tablet type device since they do not cause unevenness on pressing the touch-sensitive panel and suffer from a small change in color depending on the viewing angle, as compared to a VA (vertical alignment) type liquid crystal display device.

The IPS type and FFS type liquid crystal display devices also have embodiments that perform optical compensation with a retardation film for further enhancing the image quality and the contrast (see, for example, JP-A 2007-191505 and JP-A 2007-279083, which are expressly incorporated herein by reference in their entirety).

The retardation film used therein is often a retardation film that has a large in-plane retardation value.

Display devices are being enhanced in resolution in recent years, for example, a so-called 4K₂K display (3,840×2,160 pixels) and the like. The increase of the number of pixels with the same display size means the decrease of the pixel size, and particularly the aperture ratio, and the constitutional members of the display devices are demanded to have an extremely uniform plane without unevenness.

An optical film used in the display devices may have an issue on optical unevenness caused by the operations in production thereof, and there have been proposals for decreasing the optical unevenness, for example, by controlling the fluctuation of the slow axis described in JP-A 2008-255340, which is expressly incorporated herein by reference in its entirety, for suppressing the optical unevenness from occurring.

### SUMMARY OF THE INVENTION

An object of the invention is to solve the problems and to provide an optical film that is suppressed in optical unevenness even with a large in-plane retardation value and achieves both a high in-plane retardation value Re and uniformity of the film, and a method for producing the same.

As a result of earnest investigations made by the present inventors, it has been found that a stretching operation with a high stretching ratio is necessarily considered for providing a large in-plane retardation value, and it is difficult to provide a uniform plane by the measures having been proposed in the art. As a result of investigations on various materials and conditions, it has been found that the problems may be solved by paying attention to the thermal behavior of the elastic modulus of the material until stretching.

Specifically, it has been found that a film having a large in-plane retardation value Re exceeding 80 nm has a correlation between the change in elastic modulus and the optical unevenness within a temperature range of from a temperature where E′RT is 1/10 to a temperature where E′RT is 1/100, wherein E′ represents the storage modulus of the material of the film, and E′RT represents the storage modulus at room temperature thereof.

As a result of earnest investigations made by the inventors based on the findings, it has been found that on conveying the film to the stretching process under heating, while depending on the temperature characteristics of the elastic modulus of the material constituting the film, the film may have unevenness of elastic modulus, i.e., microscopic nonuniform distribution of the elastic modulus within the film caused by the state of releasing the residual stress due to the preceding process step, stress from conveyance tension, and unevenness of temperature within the film on heating to the stretching temperature, and the unevenness of elastic modulus and the unevenness of temperature inside the film are combined to prevent the effect, which is obtained by stretching, from being exhibited uniformly, thereby causing optical unevenness. Thus, the invention has been completed.

The invention relates to as one aspect an embodiment shown by the item (1) below and preferred embodiments shown by the items (2) to (12) below.

(1) An optical film that:

has a thickness of from 20 to 60 μm;

has an in-plane retardation value Re (550) at a wavelength of 550 nm of larger than 80 nm and equal to 350 nm or less;

has an elastic modulus Em in a direction that is in parallel or perpendicular to one arbitrary edge of the film and provides a maximum elastic modulus of the film, and an elastic modulus Es in a direction that is perpendicular to the direction of Em, the elastic modulus Em and the elastic modulus Es satisfying the relationship Em/Es of from 1.5 to 2.5; and

satisfies a relationship shown by the following expression:

$$- 0.14 ≦ \frac{log {E}_{T 10}^{′} - log {E}_{T 100}^{′}}{{T}_{10} - {T}_{100}} ≦ - 0.02$$

wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

(2) The optical film according to the item (1), wherein the optical film contains at least one kind of cellulose acylate having an acyl group containing an aromatic group at a total degree of substitution of from 0.1 to 2.0, an acyl group having an aliphatic group having from 2 to 4 carbon atoms at a total degree of substitution of from 2.0 to 2.6, or the both.

(3) The optical film according to the item (1) or (2), wherein the optical film has an in-plane retardation value Re(550) at a wavelength of 550 nm of from 200 to 350 nm.

(4) The optical film according to any one of the items (1) to (3), wherein the optical film has a retardation value Rth(500) at a wavelength of 550 nm in a thickness direction of from −50 to 50 nm.

(5) The optical film according to any one of the items (2) to (4), wherein the optical film contains, as a major component, a cellulose substituted with an acyl group having an aromatic group, and the acyl group having an aromatic group is represented by the following general formula (I):

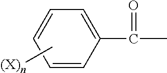

wherein X represents a hydrogen atom or a substituent; and n represents 0 or an integer of from 1 to 5, provided that when n is 2 or more, plural atoms or groups represented by X may be bonded to each other to form a condensed polycyclic ring.

(6) The optical film according to any one of the items (2) to (4), wherein the optical film contains, as a major component, the cellulose substituted with an acyl group having an aliphatic group, and the acyl group having an aliphatic group is an aliphatic acyl group having from 2 to 4 carbon atoms.

(7) The optical film according to the item (6), wherein the optical film has a liquid crystal compound layer on the film containing, as a major component, the cellulose substituted with an acyl group having an aliphatic group having from 2 to 4 carbon atoms.

(8) The optical film according to any one of the items (2) to (6), wherein the optical film contains one kind of the acyl group having an aromatic group and two kinds of the acyl groups having an aliphatic group.

(9) The optical film according to any one of the items (1) to (8), wherein the optical film further contains an ester oligomer.

(10) A method for producing the optical film according to any one of the items (1) to (9), the method containing a step of stretching a film at a ratio of from 50 to 120% at a stretching temperature in a range of Tg±20° C.

(11) A polarizing plate containing a polarizing film and the optical film according to any one of the items (1) to (9).

(12) A liquid crystal display device containing the polarizing plate according to the item (11).

According to the invention, an optical film may be provided that is suppressed in optical unevenness even with a large in-plane retardation value and achieves both a high in-plane retardation value Re and uniformity of the film, and a method for producing the same is also provided.

### BRIEF DESCRIPTION OF THE DRAWINGS

FIG. 1 is a graph of log E′ for the ordinate depending on the temperature for the abscissa in Example 1 within a range of from the temperature where E′RT becomes 1/10 to the temperature where E′RT becomes 1/100.

FIG. 2 is a graph of log E′ for the ordinate depending on the temperature for the abscissa in Comparative Example 1 within a range of from the temperature where E′RT becomes 1/10 to the temperature where E′RT becomes 1/100.

### DESCRIPTION OF EMBODIMENTS

The invention will be described in detail below.

Re(λ) and Rth(λ) represent the in-plane retardation and the retardation in the thickness direction, respectively, at the wavelength λ. Re(λ) may be measured with KOBRA 21ADH or WR (produced by Oji Scientific Instruments Co., Ltd.) with light having a wavelength λ nm incident in the normal direction of the film. The measurement wavelength λ nm may be selected by exchanging the wavelength selection filter manually or converting the measured value with an application program. In the case where the film to be measured is expressed by a uniaxial or biaxial optical indicatrix, Rth(λ) may be calculated according to the following method. The measurement method may be partially utilized in the measurement of the average tilt angle of the discotic liquid crystal molecule in the optical anisotropic layer on the side of the orientation film and the average tilt angle thereof on the opposite side, which are described later.

Rth(λ) is measured in the following manner. Re(λ) is measured for six points in total by making light having a wavelength of λ nm incident on the film in the directions of from the normal direction of the film with the in-plane slow axis (which is determined with KOBRA 21ADH or WR) as the tilt axis (rotation axis) (where there is no slow axis, an arbitrary in-plane direction of the film is used as the rotation axis) to 50° on one side of the film with a step of 10°, and Rth(λ) is calculated with KOBRA 21ADH or WR based on the retardation values thus measured, the assumed value of the average refractive index, and the input film thickness. In the aforementioned manner, for the film having such a direction that provides zero for the retardation value at a certain tilt angle from the normal direction with the in-plane slow axis as the rotation axis, the retardation value at a tilt angle larger than that tilt angle is changed in sign and subjected to the calculation with KOBRA 21ADH or WR. Rth may also be calculated in the following manner. Retardation values are measured in arbitrary two tilt directions with the slow axis as the tilt axis (rotation axis) (where there is no slow axis, an arbitrary in-plane direction of the film is used as the rotation axis), and Rth is calculated with the following expressions (A) and (B) based on the retardation values thus measured, the assumed value of the average refractive index, and the input film thickness.

$$Re ( θ ) = [ nx - \frac{ny \times nz}{\sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}}} ] \times \frac{d}{cos ( {sin}^{- 1} ( \frac{sin ( - θ )}{nx} ) )} \qquad ( A )$$

wherein Re(θ) shows the retardation value in the direction tilted by an angle θ from the normal direction; nx shows the refractive index in the in-plane slow axis direction; ny shows the refractive index in the in-plane direction perpendicular to nx; nz shows the refractive index in the direction perpendicular to nx and ny; and d shows the film thickness.

Rth=((nx+ny)/2−nz)×d (B)

For the film to be measured that is not expressed by a uniaxial or biaxial optical indicatrix, i.e., the film that does not have a so-called optical axis, Rth(λ) is measured in the following method. Re(λ) is measured for eleven points by making light having a wavelength of λ nm incident on the film in the directions of from −50° to +50° with a step of 10° with respect to the normal direction of the film with the in-plane slow axis (which is determined with KOBRA 21ADH or WR) as the tilt axis (rotation axis), and Rth(λ) is calculated with KOBRA 21ADH or WR based on the retardation values thus measured, the assumed value of the average refractive index, and the input film thickness. In the aforementioned measurements, the assumed value of the average refractive index may be the values shown in Polymer Handbook (John Wiley & Sons, Inc.) and the brochures of the optical films. For the film with an unknown average refractive index, the film may be measured for the average refractive index with an Abbe refractometer. Examples of the average refractive indices of the major optical films are shown below.

cellulose acylate: 1.48
cycloolefin polymer: 1.52
polycarbonate: 1.59
polymethyl methacrylate: 1.49
polystyrene: 1.59

The values of nx, ny and nz are calculated with KOBRA21ADH or WR by inputting the assumed value of the average refractive index and the film thickness. The value Nz is calculated according to the following expression based on nx, ny and nz thus calculated.

Nz=(nx−nz)/(nx−ny)

### Optical Film

The optical film of the invention has a thickness of from 20 to 60 μm; has an in-plane retardation value Re(550) at a wavelength of 550 nm of larger than 80 nm and equal to 350 nm or less; has an elastic modulus Em in a direction that is in parallel or perpendicular to one arbitrary edge of the film and provides the maximum elastic modulus of the film, and an elastic modulus Es in a direction that is perpendicular to the direction of Em, where the elastic modulus Em and the elastic modulus Es satisfy the relationship Em/Es of from 1.5 to 2.5; and satisfies the relationship shown by the following expression:

$$- 0.14 ≦ \frac{log {E}_{T 10}^{′} - log {E}_{T 100}^{′}}{{T}_{10} - {T}_{100}} ≦ - 0.02$$

wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

The film of the invention, which has a small thickness, may lose rigidity on measurement under heating, and the measurement accuracy may be deteriorated. As a result of consideration on the measurement conditions, it has been found that the retardation is advantageously measured with less errors by obtaining from values measured at T₁₀ and T₁₀₀. The measurement temperature is not limited to this temperature range as far as high accuracy is obtained on the measurement since the same range may be obtained under the measurement conditions on heating around the glass transition temperature.

The optical film of the invention has a thickness of from 20 to 60 μm, preferably from 25 to 50 μm, and more preferably from 30 to 45 μm.

When the film thickness is 20 μm or more, the film may have good handleability, and when the film thickness is 60 μm or less, the film may be advantageously applied to a tablet type device, a mobile display device and the like, which particularly require reduction in thickness.

The optical film of the invention has an in-plane retardation value Re(550) at a wavelength of 550 nm of larger than 80 nm and equal to 350 nm or less (80 nm<Re(550)≦350 nm), preferably from 200 to 350 nm, and more preferably from 210 to 320 nm.

The optical film of the invention preferably has a retardation value Rth(500) at a wavelength of 550 nm in the thickness direction of from −50 to 50 nm, more preferably from −40 to 40 nm, and particularly preferably from −30 to 30 nm. The optical film of the invention preferably has such characteristics that exhibit an Nz value of approximately 0.5 (specifically from 0.25 to 0.65). The film that satisfies these optical characteristics may be advantageously used as an optical compensation film of an IPS type or FFS type liquid crystal display device.

The optical film of the invention has an elastic modulus Em in a direction that is in parallel or perpendicular to one arbitrary edge of the film and provides the maximum elastic modulus of the film, and an elastic modulus Es in a direction that is perpendicular to the direction of Em, where the elastic modulus Em and the elastic modulus Es satisfy the relationship Em/Es of from 1.5 to 2.5, preferably from 1.52 to 2.1, and more preferably from 1.55 to 2.0. Specifically, the elastic modulus in a direction that is in parallel to one arbitrary edge of the film is measured, and the elastic modulus in a direction that is perpendicular to the edge of the film is measured, from which the ratio Em/Es is obtained.

When the ratio Em/Es is 1.5 or more, optical anisotropy may be easily exhibited, and when the ration Em/Es is 2.5 or less, the film may be prevented from being broken.

The optical film of the invention satisfies the relationship shown by the aforementioned expression, where E′ represents a storage modulus of the film measured by dynamic viscoelastic measurement, and E′RT represents the storage modulus of the film at room temperature. Specifically, the gradient of log E′, which is logarithm of the storage modulus E′, for the ordinate depending on the temperature for the abscissa, within a range of from the temperature where E′RT becomes 1/10 to the temperature where E′RT becomes 1/100, is from −0.14 to −0.02, preferably from −0.13 to −0.03, and more preferably from −0.12 to −0.04.

When the gradient is −0.14 or more, optical unevenness, which occurs due to failure in controlling the film uniform by the tension on stretching, may be prevented from occurring, and when the gradient is −0.02 or less, unevenness in elastic modulus may be prevented from occurring.

The room temperature referred herein is 25° C.

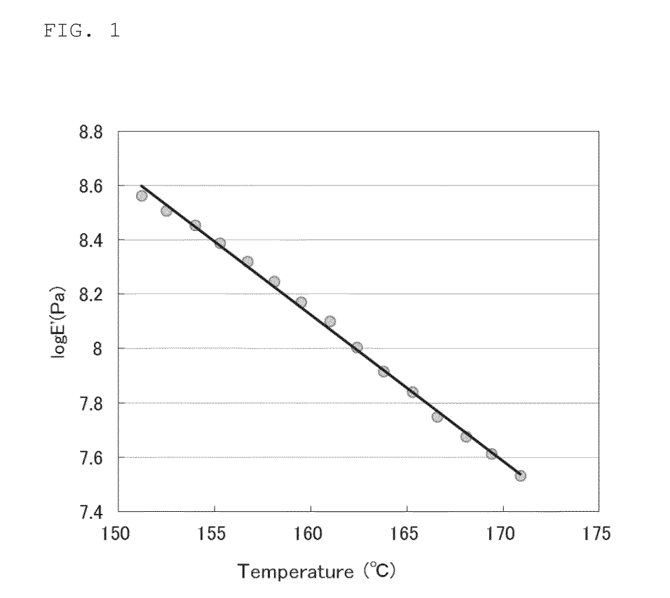

Specifically, as in one example shown in FIG. 1, the temperature where E′RT becomes 1/10 is 151.0° C., and the temperature where E′RT becomes 1/100 is 172.0° C. The gradient of log E′ within a range of from 151.0 to 172.0° C. is −0.0539 according to the aforementioned expression, which is in the range of from −0.14 to −0.02. Accordingly, the film may be advantageously used as an optical compensation film of an IPS type or FFS type liquid crystal display device.

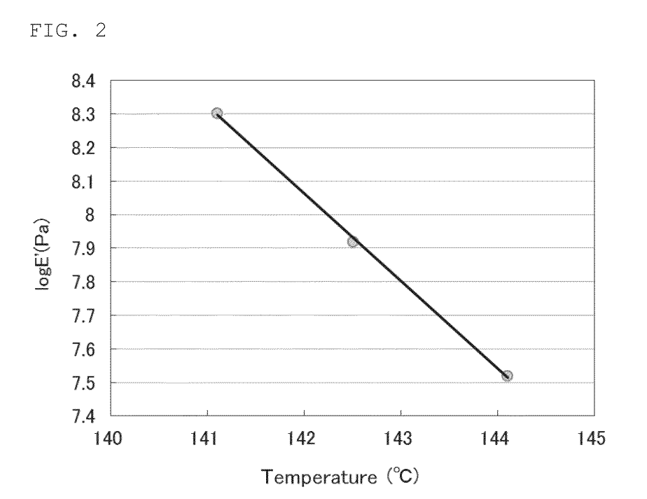

On the other hand, as in another example shown in FIG. 2, the temperature where E′RT becomes 1/10 is 141.0° C., and the temperature where E′RT becomes 1/100 is 144.0° C. The gradient of log E′ within a range of from 141.0 to 144.0° C. is −0.2607 as obtained in the same manner as in FIG. 1. While described in detail later, the film shown in FIG. 2 may not be suitable for an optical compensation film due to the large optical unevenness thereof.

The storage modulus E′ and the storage modulus at room temperature E′RT are values that are measured by dynamic viscoelastic measurement of an optical film having a residual solvent amount of 0.2% or less, and may be measured, for example, with DVA200, produced by IT Keisoku Seigyo, Co. Ltd.

The optical film of the invention is not particularly limited in material and the like, as far as it has the prescribed thickness, the prescribed retardation values and the prescribed gradient. One example thereof is a film containing cellulose acylate as a major component, and one specific example thereof is a film that contains at least one kind of cellulose acylate having an acyl group containing an aromatic group (which may be hereinafter referred to as an aromatic acyl group) at a total degree of substitution of from 0.1 to 2.0 or an acyl group having an aliphatic group having from 2 to 4 carbon atoms (which may be hereinafter referred to as an aliphatic acyl group) at a total degree of substitution of from 2.0 to 2.6.

The cellulose acylate will be described in detail below.

### Cellulose Acylate

The cellulose acylate of the invention has a total degree of substitution of an aromatic acyl group of from 0.1 to 2.0 or a total degree of substitution of an aliphatic acyl group having from 2 to 4 carbon atoms of from 2.0 to 2.6. The total degree of substitution referred herein means the sum of the degrees of substitution at the 2-, 3- and 6-positions of the cellulose acylate.

The cellulose acylate having an aromatic acyl group preferably satisfies the following expression (1):

(DS2+DS3)/2>DS6 (1)

wherein DS2, DS3 and DS6 represent the degrees of substitution of an aromatic acyl group at the 2-, 3- and 6-positions of the cellulose acylate.

### Acyl Group Containing Aromatic Group

The acyl group containing an aromatic group (i.e., the aromatic acyl group) in the invention may be bonded directly to the ester bond moiety or may be bonded thereto through a linking group. The aromatic acyl group is preferably bonded directly thereto. Examples of the linking group herein include an alkylene group, an alkenylene group and an alkynylene group, and the linking group may have a substituent. Preferred examples of the linking group include an alkylene group, an alkenylene group and an alkynylene group, which each have from 1 to 10 carbon atoms, more preferred examples thereof include an alkylene group and an alkenylene group, which each have from 1 to 6 carbon atoms, and particularly preferred examples thereof include an alkylene group and an alkenylene group, which each have from 1 to 4 carbon atoms.

The elastic modulus of cellulose is presumed to be derived from interaction, entanglement and the like of the cellulose molecular chains, and therefore the aromatic acyl group, which is more bulky and has higher activity than the aliphatic acyl group, has a larger effect thereon than the aliphatic acyl group. Accordingly, in the mixed acid ester of cellulose having both the aromatic acyl group and the aliphatic acyl group having an aliphatic group having from 2 to 4 carbon atoms substituted thereon, the total degree of substitution of the aromatic acyl group is dominant on the expression of the retardation irregular region rather than the total degree of substitution, and therefore the elastic modulus of the cellulose acylate having the aromatic acyl group may be determined by paying attention to the total degree of substitution of the aromatic acyl group.

The aromatic group of the aromatic acyl group may have a substituent, and examples of the substituent substituted on the aromatic group and the substituent substituted on the linking group described above include the substituents described in JP-A 2009-235374, paragraphs (0010) to (0013), which is expressly incorporated herein by reference in its entirety.

The aromatic acyl group is more preferably a substituent represented by the following general formula (I):

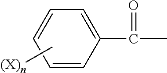

wherein X represents a hydrogen atom or a substituent; and n represents 0 or an integer of from 1 to 5, provided that when n is 2 or more, plural atoms or groups represented by X may be bonded to each other to form a condensed polycyclic ring.

In the invention, the non-substituted aromatic acyl group is preferably used from the standpoint of the acylation process and the handleability of cellulose, and in the case where the aromatic acyl group is modified by substitution, preferred examples of the substituent represented by X include the substituents described in Japanese Patent No. 4,065,696, paragraphs (0005) to (0020), which is incorporated herein by reference.

The aromatic acyl group contained in the cellulose acylate may be used solely or as a combination of two or more kinds thereof.

The total degree of substitution of the aromatic acyl group is from 0.1 to 2.0, preferably from 0.3 to 1.5, and more preferably from 0.5 to 1.2.

Examples of the method of substitution of the aromatic acyl group on the hydroxyl group of cellulose include a method of using an aromatic carboxylic acid chloride or a symmetric acid anhydride or a mixed acid anhydride derived from an aromatic carboxylic acid. Particularly preferred examples of the method include a method of using an acid anhydride derived from an aromatic carboxylic acid (see, for example, J. Appl. Polym. Sci., vol. 29, pp. 3981-3990 (1984)).

### Aliphatic Acyl Group

The cellulose acylate may contain only the aliphatic acyl group or may be a mixed acid ester of the aromatic acyl group and the aliphatic acyl group.

Plural kinds of the cellulose acylate may be used in the invention, and in the invention, an embodiment where the cellulose acylate having the aromatic acyl group is contained in an amount of 50 parts by mass or more for constituting the major component may further effectively provide the advantages of the invention.

In the case where the cellulose acylate contains only the aliphatic acyl group in the invention, the aliphatic acyl group may be any of linear, branched and cyclic structures having from 2 to 4 carbon atoms, and may be an aliphatic acyl group containing an unsaturated bond. Preferred examples of the aliphatic acyl group include an acetyl group, a propionyl group and a butyryl group, and among these, an acetyl group is more preferred. When the aliphatic acyl group is an acetyl group, a film that has appropriate glass transition point (Tg), elastic modulus and the like may be obtained. The use of the aliphatic acyl group having from 2 to 4 carbon atoms, such as an acetyl group, imparts suitable strength to the film while preventing Tg and the elastic modulus from being lowered.

The total degree of substitution of the aliphatic acyl group is from 2.0 to 2.6, preferably from 2.1 to 2.6, and more preferably from 2.2 to 2.55.

In the case of the mixed acid ester of the aromatic acyl group and the aliphatic acyl group, it is preferred that the total degree of substitution of the aromatic acyl group is from 0.3 to 1.0, and the total degree of substitution of the aliphatic acyl group is from 1.0 to 2.5, and it is more preferred that the total degree of substitution of the aromatic acyl group is from 0.6 to 0.9, and the total degree of substitution of the aliphatic acyl group is from 1.5 to 2.3.

For the methods of procurement and preparation of the cellulose acylate, reference may be made to JP-A 2009-235374, paragraphs (0021) to (0024), and U.S. Patent Application 2010/0267942, which are expressly incorporated herein by reference in their entirety.

Specific examples of the cellulose acylate that may be used in the invention are shown in Table 1 below, but the invention is not limited to the examples.

TABLE 1

| | | Total Degree of | | Total degree of |
|---|---|---|---|---|
| | Aromatic | substitution of | Aliphatic | substitution of |
| No. | acyl group | aromatic acyl group | acyl group | aliphatic acyl group |
| A-1 | — | — | acetyl | 2.1 |
| A-2 | benzoyl | 0.7 | acetyl | 2.2 |
| A-3 | — | — | acetyl | 2.55 |
| A-4 | benzoyl | 0.9 | — | — |
| A-5 | benzoyl | 1.5 | — | — |
| A-6 | benzoyl | 1.0 | acetyl | 1.5 |
| A-7 | benzoyl | 0.7 | propionyl | 2.2 |
| A-8 | benzoyl | 1.0 | propionyl | 1.8 |
| A-9 | benzoyl | 0.8 | acetyl | 0.5 |
| | | | propionyl | 1.5 |

The cellulose acylate that may be used in the invention preferably contains one kind of the acyl group having an aromatic group and two kinds of the acyl groups having an aliphatic group.

### Cellulose Acylate Composition

A cellulose acylate composition that may be used in the invention will be described.

The cellulose acylate composition used for producing the optical film of the invention contains at least one kind of the cellulose acylate.

The cellulose acylate composition contains the cellulose acylate preferably in an amount of from 70 to 100% by mass, more preferably from 80 to 100% by mass, and further preferably from 90 to 100% by mass, based on the total amount of the composition.

The cellulose acylate composition may be in various forms, such as a particle form, a powder form, a fiber form, a bulk form, a solution and a melt.

A particle form or a powder form is preferred as a raw material for producing a film, and therefore the cellulose acylate composition after drying may be pulverized and classified for uniformizing the particle size and enhancing the handleability thereof.

In the case where the film is produced with the cellulose acylate composition by a solution casting method described later, the cellulose acylate composition may be used in the form of a dope by dissolving in a solvent.

In the invention, the cellulose acylate may be used solely or as a mixture of two or more kinds thereof. A polymer component other than the cellulose acylate, and various additives may also be mixed in the composition. The components to be mixed preferably have excellent compatibility with the cellulose acylate, and preferably provide on forming into the film a transmittance of 80% or more, more preferably 90% or more, and particularly preferably 92% or more.

In the invention, various additives that may be ordinarily added to cellulose acylate (such as an ultraviolet ray absorbent, a plasticizer, a degradation preventing agent, fine particles and an optical property modifier) may be added to the cellulose acylate to provide a composition. The additives added to the cellulose acylate may be added at any time during the production of the dope, and may be added after completing the preparation of the dope. The amount of the additives added is preferably from 0.1 to 25 parts by mass, relative to 100 parts by mass of the contained cellulose acylate.

### Plasticizer

In the invention, a plasticizer may be used as an additive for controlling the mechanical properties and the processability of the film. A plasticizer that has good compatibility with the cellulose acylate may be effective for providing a film having high quality and high durability since the plasticizer may suffer less bleeding, may provide low haze, and may lower the water content and the moisture permeability.

The plasticizer that may be used in the cellulose acylate film is not particularly limited, and examples thereof include a phosphate ester plasticizer, a phthalate ester plasticizer, a polyhydric alcohol ester plasticizer, a polycarboxylic acid ester plasticizer, a glycolate plasticizer, a citrate ester plasticizer, a fatty acid ester plasticizer, a carboxylic acid ester plasticizer, an ester oligomer such as a polyester oligomer plasticizer, a sugar ester plasticizer and a plasticizer based on a copolymer of an ethylenically unsaturated monomer.

Preferred examples of the plasticizer include a phosphate ester plasticizer, a phthalate ester plasticizer, a polyhydric alcohol ester plasticizer, a polyester oligomer plasticizer, a sugar ester plasticizer and a plasticizer based on a copolymer of an ethylenically unsaturated monomer. More preferred examples thereof include a polyhydric alcohol ester plasticizer, a polyester oligomer plasticizer and a sugar ester plasticizer, further preferred examples thereof include a polyester oligomer plasticizer and a sugar ester plasticizer, and a particularly preferred example thereof is a polyester oligomer plasticizer.

In the invention, the plasticizer may be used solely or as a mixture of two or more kinds thereof.

The content of the plasticizer is preferably from 0.1 to 50% by mass, more preferably from 1 to 30% by mass, further preferably from 5 to 20% by mass, and particularly preferably from 7 to 15% by mass, based on the cellulose acylate.

The values of Re and Rth of the optical film of the invention may be controlled mainly by the distribution of the degrees of substitution of the aromatic acyl group and the aliphatic acyl group at the 2-, 3- and 6-positions of the cellulose acylate and stretching ratio. Specifically, the optical film of the invention has an Re (550) value of larger than 80 nm and equal to 350 nm or less, and preferably from 200 to 350 nm, and preferably has an Rth (550) value of from −50 to 50 nm, and more preferably from −30 to 30 nm. The optical film of the invention preferably has such characteristics that exhibit an Nz value of approximately 0.5 (specifically from 0.25 to 0.65). However, the optical characteristics of the optical film of the invention are not limited to these ranges.

The variation of the Re(550) value in the width direction of the film is preferably ±5 nm, and more preferably ±3 nm. The variation of the Rth(550) value in the width direction of the film is preferably ±10 nm, and more preferably ±5 nm. The variations of the Re and Rth values in the machine direction of the film are preferably within the variation ranges in the width direction, respectively.

### Method for Producing Optical Film

The method for producing the optical film (cellulose acylate film) of the invention contains a step of stretching a film at a ratio of from 50 to 120% at a stretching temperature in a range of Tg±20° C.

The method for producing the optical film of the invention is not particularly limited, and the optical film of the invention is produced preferably by a melt film forming method or a solution film forming method, which are described later, and more preferably by a solution film forming method.

For the melt film forming method, reference may be made, for example, to JP-A 2006-348123, which is expressly incorporated herein by reference in its entirety, and for the solution film forming method, reference may be made, for example, to JP-A 2006-241433, which is expressly incorporated herein by reference in its entirety.

In the method for producing the cellulose acylate film, the cellulose acylate is dissolved in a solvent to prepare a dope. In the invention, the film is preferably produced by a solution film forming method, and specifically, a dope, which is prepared by dissolving a polymer in an organic solvent, is cast on a surface of a support, which is formed of a metal or the like, and then dried to form a film. Thereafter, the film is released from the surface of the support and then stretched.

### Solution Film Forming Method

In the solution film forming method, a solution of the cellulose acylate is prepared, and the solution is cast on a surface of a support to form a film. The solvent used for preparing the cellulose acylate solution is not particularly limited. Preferred examples of the solvent include a chlorine organic solvent, such as dichloromethane, chloroform, 1,2-dichloroethane and tetrachloroethylene, and a non-chlorine organic solvent. The non-chlorine organic solvent is preferably selected from an ester, a ketone and an ether, which each have from 3 to 12 carbon atoms. The ester, ketone and ether may have a cyclic structure. A compound having two or more kinds of the functional groups of the ester, ketone and ether (i.e., —O—, —CO— and —COO—) may be used as a main solvent, and may have other functional groups, such as an alcoholic hydroxyl group. The main solvent that has two or more kinds of the functional groups may have a number of carbon atoms that is within the range for a compound having any one of the functional groups. Examples of the ester compound having from 3 to 12 carbon atoms include ethyl formate, propyl formate, pentyl formate, methyl acetate, ethyl acetate and pentyl acetate. Examples of the ketone compound having from 3 to 12 carbon atoms include acetone, methyl ethyl ketone, diethyl ketone, diisobutyl ketone, cyclopentanone, cyclohexanone and methylcyclohexanone. Examples of the ether compound having from 3 to 12 carbon atoms include diisopropyl ether, dimethoxymethane, dimethoxyethane, 1,4-dioxane, 1,3-dioxolane, tetrahydrofuran, anisole and phenetol. Examples of the organic solvent having two or more kinds of the functional groups include 2-ethoxyethyl acetate, 2-methoxyethanol and 2-butoxyethanol.

In the preparation of the cellulose acylate solution, the cellulose acylate is preferably dissolved in the organic solvent in an amount of from 10 to 35% by mass, more preferably from 13 to 30% by mass, and particularly preferably from 15 to 28% by mass. The cellulose acylate solution having a concentration within the range may be prepared by controlling the concentration on dissolving the cellulose acylate in the solvent, and may be prepared by forming a low concentration solution (for example, from 9 to 14% by mass) in advance, and then concentrating the solution to form the solution having a concentration within the range. The cellulose acylate solution may also be prepared by forming a high concentration solution in advance, and then adding various additives thereto to form the cellulose acylate solution having a concentration within the range.

On preparing the cellulose acylate solution (i.e., the dope), the dissolution method is not particularly limited, and the cellulose acylate may be dissolved at room temperature or may be dissolved by a cooling dissolution method, a high-temperature dissolution method or a combination thereof. For these methods, reference may be made, for example, to the preparation method of the cellulose acylate solution described in JP-A 5-163301, JP-A 61-106628, JP-A 58-127737, JP-A 9-95544, JP-A 10-95854, JP-A 10-45950, JP-A 2000-53784, JP-A 11-322946, JP-A 11-322947, JP-A 2-276830, JP-A 2000-273239, JP-A 11-71463, JP-A 04-259511, JP-A 2000-273184, JP-A 11-323017 and JP-A 11-302388, which are expressly incorporated herein by reference in their entirety. For the details of the methods, particularly the preparation method using a non-chlorine solvent, reference may be made to JIII Journal of Technical Disclosure, No. 2001-1745 (Mar. 15, 2001), pp. 22-25, which is incorporated by reference. In the process of preparation of the cellulose acylate solution, such process steps as concentration, filtration and the like of the solution may be performed, and for these process steps, reference may be made to JIII Journal of Technical Disclosure, No. 2001-1745 (Mar. 15, 2001), p. 25, which is incorporated by reference. In the case where the cellulose acylate is dissolved at a high temperature, which is often higher than the boiling point of the organic solvent used, the solvent may be used under pressure.

### Specific Method of Solution Film Forming Method

As the method and equipment for producing the cellulose acylate film, a solution cast film forming method and a solution cast film forming equipment, which have been ordinarily used for producing a cellulose acylate film, may be used. A dope (cellulose acylate solution) prepared in a dissolution device (tank) is once stored in a storing tank, and the dope is defoamed. The dope is fed to a pressure die from the dope discharging port, for example, with a pressure metering gear pump capable of feeding a prescribed amount of the solution precisely through the rotation number, and the dope is cast through the slit of the pressure die uniformly on the metal support of the cast member, which runs endlessly. At the releasing point where the metal support makes about one round, the damp-dried dope film (which may also be referred to as a web) is released from the metal support. The resulting web is dried while transporting by a tenter with the width of the web maintained by clipping both ends thereof, and the web is transported with the group of rolls of the drying device to complete drying and wound in a prescribed length with a winder. The combination of the tenter and the drying device including the group of rolls may vary depending on the purpose thereof. The solution cast film forming method that is used for a silver halide photographic light-sensitive material and a functional protective film for an electronic display may often include, in addition to the solution cast film forming device, a coating device for performing a surface treatment on the film, for example, formation of an undercoating layer, an antistatic layer, an antihalation layer, a protective layer and the like. For these production steps, reference may be made to JIII Journal of Technical Disclosure, No. 2001-1745 (Mar. 15, 2001), pp. 25-30, which is incorporated by reference, the description of which is classified into flow casting (including co-flow casting), metal support, drying, releasing, stretching and the like.

### Stretching

The optical film of the invention thus produced by the melt film forming method or the solution film forming method is subjected to a stretching treatment for providing an Re (550) value of larger than 80 nm and equal to 350 nm or less.

The stretching treatment may be performed in-line during the film forming process or may be performed after completing the film formation and winding. Specifically, in the melt film forming method, the stretching treatment may be performed in a state where the cooling of the film is not completed, or may be performed after completing the cooling.

The stretching treatment is performed at a stretching temperature in a range of Tg±20° C., preferably Tg±18° C., and more preferably Tg±15° C.

The stretching ratio is from 50 to 120%, preferably from 50 to 110%, and more preferably from 50 to 100%. The stretching treatment may be performed through only one stage or through multiple stages. The stretching ratio herein is obtained by the following expression.

stretching ratio(%)=100×((length after stretching)−(length before stretching))/(length before stretching)

The stretching treatment may be performed by a known stretching method, such as stretching in machine direction, stretching in transverse direction, and a combination thereof. The stretching in machine direction may be performed, for example, by (1) roll stretching, which may also be referred to as free edge stretching, in which the film is stretched in the machine direction with two or more pairs of nip rolls where the output rolls have a larger circumferential velocity, and (2) fixed edge stretching, in which the film is transported in the machine direction at a velocity that is gradually increased while holding both edges of the film, thereby stretching the film in the machine direction. The stretching in transverse direction may be performed, for example, by tenter stretching, in which both ends of the film are held with chucks, and the film is stretched by expanding the chucks in the transverse direction (which is perpendicular to the machine direction). Only any one of the stretching in machine direction and the stretching in transverse direction may be performed (uniaxial stretching), or a combination thereof may be performed (biaxial stretching). For performing the biaxial stretching, stretching in machine direction and stretching in transverse direction may be performed sequentially (sequential stretching) or may be performed simultaneously (simultaneous stretching).

The stretching speeds of stretching in machine direction and stretching in transverse direction may be from 40 to 400%/min, preferably from 60 to 350%/min, and more preferably from 100 to 300%/min. In the stretching through multiple stages, the stretching speed means the average value of the stretching speeds of the stages.

Subsequent to the stretching treatment, a relaxing treatment may be performed for such purposes as relaxing the internal stress caused by stretching. In the case where the relaxing treatment is performed, the film is preferably relaxed in the machine direction or the transverse direction by from 0 to 10%. Subsequent to the stretching treatment, furthermore, a heat setting treatment is preferably performed at from 150 to 250° C. for from 1 second to 3 minutes.

The angle θ formed between the film forming direction (i.e., the machine direction) and the slow axis of the retardation of the film is preferably as close as to 0°, +90° or −90°. Specifically, in the stretching in machine direction, the angle θ is preferably as close as to 0°, and is preferably 0±3°, more preferably 0±2°, and particularly preferably 0±1°. In the stretching in transverse direction, the angle θ is preferably 90±3° or −90±3°, more preferably 90±2° or −90±2°, and particularly preferably 90±1° or −90±1°.

The stretching treatment may be performed during the film forming process, or a raw film thus formed and wound may be subjected to the stretching treatment. In the former case, the film may be stretched in a state where the film contains a residual solvent, and may be preferably stretched with a residual solvent amount of from 2 to 30% by mass.

The optical film thus obtained after drying has a thickness that may vary depending on the purpose, and may be from 20 to 60 μm, preferably from 25 to 50 μm, and more preferably from 30 to 45 μm. The thickness of the film may be controlled to a desired thickness by adjusting the solid concentration in the dope, the slit width of the die, the pressure for extruding from the die, the velocity of the metal support, and the like.

The optical film of the invention may be produced in the form of a long strip, for example, a wound long film having a width of from 0.5 to 3 m (preferably from 0.6 to 2.5 m, and more preferably from 0.8 to 2.2 m) and a length of from 100 to 10,000 m (preferably from 500 to 7,000 m, and more preferably from 1,000 to 6,000 m) per one roll. The film is preferably knurled at least on one edge thereof on winding, and the knurling preferably has a width of from 3 to 50 mm, and more preferably from 5 to 30 mm, and a height of from 0.5 to 500 μm, and more preferably from 1 to 200 μm. The knurling may be single side knurling or double side knurling.

The stretched cellulose acylate film may be used solely, may be used as a polarizing plate protective film, which may also function as an optical anisotropy layer, in combination with a polarizing plate, and may be used after providing on these films a functional layer, such as a liquid crystal layer and a layer having a controlled refractive index (low reflection layer), and a hardcoat layer.

The cellulose acylate film containing an aliphatic acyl group having from 2 to 4 carbon atoms may have a liquid crystal compound layer formed by coating a liquid crystal compound. The liquid crystal compound layer may be a coated layer, and is specifically a layer containing a liquid crystal composition containing a rod-like liquid crystal as a major component with a fixed homeotropic orientation. The major component of the layer is the rod-like liquid crystal when the low molecular weight rod-like liquid crystal is contained as it is, and is the polymerized rod-like liquid crystal when the polymerizable rod-like liquid crystal is contained in the form of a polymer after performing polymerization reaction, the SP values of which are calculated respectively. The SP value of the rod-like liquid crystal is generally from 20 to 25. The major component of the liquid crystal compound layer may be selected from the rod-like liquid crystal in such a combination that provides a |ΔSP| value of 1.5 or less in relation to the SP value of the cellulose acylate containing an aliphatic acyl group having from 2 to 4 carbon atoms.

For the rod-like liquid crystal, which may be used herein, reference may be made, for example, to JP-A 2009-217256, paragraphs (0045) to (0066), which is expressly incorporated herein by reference in itsentirety. For the additive and the orientation film, which may be used herein, and the method of forming the homeotropic liquid crystal layer, reference may be made, for example, to JP-A 2009-237421, paragraphs (0076) to (0079), which is expressly incorporated herein by reference in its entirety.

The thickness of the liquid crystal compound layer is not particularly limited, and in the case where the layer is formed by coating, the thickness thereof may be approximately from 0.5 to 20 μm, and preferably from 1.0 to 15 μm.

### Retardation Film

The optical film of the invention has retardation, and thus may be used as a retardation film.

The optical film of the invention is preferably combined with the functional layers described in detail in JIII Journal of Technical Disclosure, No. 2001-1745 (Mar. 15, 2001), pp. 32-45, which is incorporated by reference. Particularly preferred examples thereof include application of a polarizing film (formation of a polarizing plate), application of an optical compensation layer formed of a liquid crystal composition (formation of an optical compensation film), and application of an antireflection layer (formation of an antireflection film).

### Optical Compensation Film

The optical film of the invention may be utilized for optical compensation of a liquid crystal display device by utilizing the retardation value thereof. In the case where the optical film of the invention satisfies the optical characteristics required for optical compensation, the optical film may be used as an optical compensation film as it is. The optical film of the invention may be used as an optical compensation film, after laminating with at least one layer for satisfying the optical characteristics required for optical compensation, for example, an optical anisotropy layer formed by curing a liquid crystal composition, and a layer formed of a birefringent polymer film.

### Polarizing Plate

The invention relates to a polarizing plate containing a polarizing film and the optical film of the invention. The polarizing plate may contain a polarizing film and two protective films that hold the polarizing film, in which at least one of the two protective films is the optical film of the invention. The optical film may be laminated on the polarizing film, as a part of an optical compensation film having an optical anisotropy layer or a part of an antireflection film having an antireflection layer. In the case where the other layers are contained, the surface of the optical film of the invention is preferably adhered to the surface of the polarizing film. For the production of the polarizing plate, reference may be made, for example, to JP-A 2006-241433, which are expressly incorporated herein by reference in their entirety.

### Image Display Device

The invention relates to an image display device containing at least one sheet of the optical film of the invention. The optical film of the invention may be used in a display device, as a retardation film or an optical compensation film, or as a part of a polarizing plate, an optical compensation film, an antireflection film or the like.

### Liquid Crystal Display Device

The invention relates to a liquid crystal display device containing the polarizing plate of the invention. The optical film of the invention may be installed in a liquid crystal display device, as a retardation film, or in the form of a polarizing plate, an optical compensation film or an antireflection film using the optical film. Examples of the liquid crystal display device include an IPS type liquid crystal display device and an FFS type liquid crystal display device. The optical film of the invention may be used in any of transmission type, reflection type and semitransmission type liquid crystal display devices.

In the case where the optical film of the invention is used in an IPS mode liquid crystal display device, one sheet of the optical film is preferably disposed between the liquid crystal cell and the polarizing plate on the side of the display surface or the polarizing plate on the side of the backlight. The optical film may be used for functioning as a protective film of the polarizing plate on the side of the display surface or the polarizing film on the side of the backlight, by installing the optical film as a part of the polarizing plate between the liquid crystal cell and the polarizing film in the liquid crystal display device. By installing one sheet of the optical film of the invention at the aforementioned position, the display characteristics of the IPS mode liquid crystal display device may be improved, and particularly the color shift at oblique view on displaying black color may be reduced. In an embodiment where the optical film is used for optical compensation of an IPS mode liquid crystal display device, the optical film of the invention preferably has an Rth value of from −50 to 50 nm, an Re value of larger than 80 nm and equal to 350 nm or less, and an Nz value of approximately 0.5, and specifically from 0.25 to 0.65. In the embodiment, the optical film of the invention is preferably disposed in such a manner that the in-plane slow axis of the optical film is in parallel or perpendicular to the absorption axis of the polarizing film on the side of the display surface (or the polarizing film on the side of the backlight).

### EXAMPLES

The invention will be described in more detail with reference to examples below. The materials, reagents, amounts and ratios of substances, and operations shown in the examples may be changed and modified unless the advantages of the invention are impaired. Accordingly, the invention is not limited to the following examples.

### Synthesis Example 1

### Synthesis of Example Compound A-1

Cellulose acylate was synthesized by the method described in JP-A 10-45804 and JP-A 08-231761, which are expressly incorporated herein by reference in their entirety, and measured for degree of substitution. Specifically, sulfuric acid as a catalyst (7.8 parts by mass per 100 parts by mass of cellulose) and a carboxylic acid as a raw material of an acyl substituent were added to cellulose, and acylation reaction was performed at 40° C. The kind and degree of substitution of the acyl group were controlled by changing the kind and amount of the carboxylic acid. After the acylation, aging was performed at 40° C. The resulting cellulose acylate was rinsed with acetone for removing low molecular weight components.

### Synthesis Example 2

### Synthesis of Example Compound A-2

Example Compound A-2 was obtained according to the method described in U.S. Patent Application 2010/0267942, paragraphs (0151) to (0153).

### Synthesis Example 3

### Synthesis of Compound B-1

Compound B-1 was synthesized according to the saponification method of cellulose acetate described in JP-A 2008-163193, paragraph (0121), which is expressly incorporated herein by reference, and the aromatic acylation method of cellulose acetate described in the same publication, paragraph (0124).

### Production Example 1

### Production of Cellulose Acylate Film

Cellulose acylate films shown in Table 3 below were produced by using the cellulose acylate produced in Synthesis Examples 1 to 3 according to the following method.

### Preparation of Cellulose Acylate Solution

The following components were placed in a mixing tank and dissolved by stirring under heating, thereby preparing a solution containing a cellulose acylate solution.

| | |
|---|---|
| Cellulose acylate shown in Table 3 | 100 parts by mass |
| Methylene chloride (first solvent) | 402 parts by mass |
| Methanol (second solvent) | 60 parts by mass |
| Polyester additive A shown below | amount shown in Table 2 |

TABLE 2
Additive A

| | | S1 |
|---|---|---|
| Molecular weight | | 800 |
| Dicarboxylic | terephthalic acid | 55 |
| acid unit | (% by mol) | |
| | phthalic acid | 0 |
| | (% by mol) | |
| | adipic acid | 0 |
| | (% by mol) | |
| | succinic acid | 45 |
| | (% by mol) | |
| Glycol unit | ethylene glycol | 50 |
| | (% by mol) | |
| | 1,2-propanediol | 50 |
| | (% by mol) | |
| | PG ratio | 50 |
| | (%) | |

| | |
|---|---|
| Terminal group | Ac |

### Production of Cellulose Acylate Film Specimen (Films 2 to 10 and 12)

562 parts by mass of the solution containing the cellulose acylate solution was cast with a band casting machine. A film having a residual solvent amount of 15% by mass was uniaxially stretched with one end thereof fixed at a stretching ratio shown in Table 3 at a temperature of (glass transition temperature+25° C.), thereby producing the cellulose acylate films shown in Table 3.

### Production Example 2

### Production of Film 1

Zeonor (produced by Zeon Corporation) was uniaxially stretched with one end thereof fixed at a stretching ratio of 80% at 150° C., thereby producing Film 1.

### Production Example 3

### Production of Film 11

Pure-Ace (produced by Teijin Chemicals, Ltd.) was dissolved in methyl chloride and formed into a film having a thickness of 150 μm, which was then uniaxially stretched with free width at a stretching ratio of 60% at 230° C., thereby producing Film 11.

### Evaluation of Film Specimen

For evaluating the film specimens, portions of the film specimens thus obtained above (120 mm×120 mm) were prepared and measured for retardation values, i.e., Re and Rth to light having a wavelength of 550 nm, with KOBRA 21ADH (produced by Oji Scientific Instruments Co., Ltd.). The results are shown in Table 4.

### Measurement of Storage Modulus

The films were measured for storage modulus and storage modulus at room temperature with DVA200, produced by IT Keisoku Seigyo, Co. Ltd.

### Gradient

The film was heated and measured for the temperature where the storage modulus at room temperature E′RT, which was measured in advance, became 1/10, and log E′ at that temperature was measured. The film was further heated and measured for the temperature where the storage modulus at room temperature E′RT became 1/100, and log E′ at that temperature was measured.

The gradient was obtained by the aforementioned expression based on these values. FIG. 1 shows the graph of the film of Example 1, and FIG. 2 shows the graph of the film of Comparative Example 1.

### Measurement of Elastic Modulus Ratio

The elastic modulus of the film was measured in the following manner.

A specimen of the film having a dimension of 10 mm×150 mm (where an arbitrary edge of the film was used as the longitudinal direction) was conditioned for humidity at 25° C. and a relative humidity of 65% for 2 hours, and measured for a stress-distortion curve by stretching in a direction in parallel to the arbitrary edge of the film in an atmosphere of 25° C. and a relative humidity of 60% with an initial specimen length of 50 mm at a rate of 10% per minute with a versatile tensile tester, STM T50BP, produced by Toyo Baldwin Corporation, thereby obtaining the elastic modulus E′ (unit: MPa) of the film in the arbitrary direction (parallel direction). Separately, the film was cut into a dimension of 150 mm×10 mm where the direction perpendicular to the arbitrary edge was used as the longitudinal direction, and stretched in the direction perpendicular to the arbitrary edge under the same conditions as above, thereby obtaining the elastic modulus E′ (unit: MPa) of the film in the direction perpendicular to the arbitrary edge (perpendicular direction). The larger value of these values of the elastic modulus was designated as Em, whereas the smaller value thereof was designated as Es, and the elastic modulus ratio (Em/Es) was calculated.

### Optical Unevenness

The film specimen thus obtained was cut into a portion (30 cm×30 cm), which was partitioned per 10 mm in the transverse direction and the machine direction into 961 points (31×31 points), and the points thus partitioned were measured for Re (550) with KOBRA 21ADH, thereby calculating the variation σ of Re. The variation σ of Re was evaluated as optical unevenness.

TABLE 3

| | | | Degree of | Degree of | | | | | | | |
|---|---|---|---|---|---|---|---|---|---|---|---|
| | | | substitution of | substitution | Additive | | Stretching | Stretching | Film | | |
| | Compound | Film | aromatic acyl | of aliphatic | (part by | | temperature | ratio | thickness | Re | Rth |
| | No. | No. | group | acyl group | mass) | | (° C.) | (%) | (μm) | (nm) | (nm) |
| Comparative | — | 1 | — | — | — | | 150 | 80 | 40 | 160 | 160 |
| Example 1 | | | | | | | | | | | |
| Comparative | B-1 | 2 | | | — | | 205 | 60 | 50 | 200 | 0 |
| Example 2 | | | | | | | | | | | |
| Example 1 | A-1 | 3 | — | 2.43 | A | (19) | 185 | 90 | 18 | 60 | 60 |
| Example 2 | A-1 | 4 | — | 2.43 | A | (19) | 185 | 90 | 43 | 95 | 95 |
| Example 8 | A-1 | 4′ | — | 2.43 | A | (19) | 182 | 60 | 42 | 100 | 110 |
| | | | | | C | (4) | | | | | |
| Comparative | A-1 | 5 | — | 2.43 | A | (19) | 185 | 90 | 62 | 120 | 120 |
| Example 3 | | | | | | | | | | | |
| Example 3 | A-1 | 6 | — | 2.43 | A | (4) | 195 | 80 | 50 | 83 | 87 |
| | | | | | B | (2) | | | | | |
| Example 4 | A-1 | 7 | — | 2.43 | — | | 202 | 80 | 50 | 91 | 95 |
| Example 5 | A-2 | 8 | 0.70 | 2.2 | — | | 201 | 50 | 25 | 90 | 10 |
| Example 6 | A-2 | 9 | 0.70 | 2.2 | — | | 201 | 80 | 45 | 260 | 12 |
| Example 7 | A-2 | 10 | 0.70 | 2.2 | — | | 201 | 80 | 58 | 340 | 25 |
| Comparative | — | 11 | — | — | — | | 230 | 60 | 120 | 160 | 78 |
| Example 4 | | | | | | | | | | | |
| Comparative | A-1 | 12 | — | 2.43 | A | (19) | 172 | 31 | 57 | 50 | 120 |
| Example 5 | | | | | | | | | | | |
| Comparative | A-1 | 13 | — | 2.43 | A | (60) | 100 | 31 | 60 | 5 | 50 |

Example 6

In Table 3, additive B and additive C show the following compounds.

### Additive B

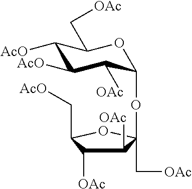

(Ac represents an acetyl group.)

### Additive C

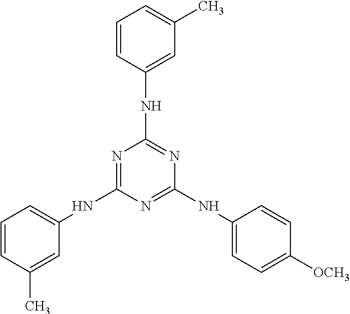 [SMILES: COc1ccc(Nc2nc(Nc3cccc(C)c3)nc(Nc3cccc(C)c3)n2)cc1]

TABLE 4

| | | Elastic | Elastic | | | | | | | | |
|---|---|---|---|---|---|---|---|---|---|---|---|
| | | modulus | modulus | | | | | | | | |
| | | at room | at room | Elastic | | | | | | | |
| | | temperature | temperature | modulus | | | | | | | |
| | | of arbitrary | of arbitrary | at | | | | | | | |
| | | edge with | edge with | room | | | | | | Elastic | Optical |
| | Film | larger value | smaller value | temperature | | | | | | modulus | uneven- |
| | No. | (×10⁹ Pa) | (×10⁹ Pa) | (×10⁹ Pa) | T₁₀ | T₁₀₀ | logE′_{T10} | logE′_{T100} | Gradient | ratio | ness |
| Comparative | 1 | 4.225 | 2.3 | 4.2 | 141.0 | 144.0 | 8.5 | 7.5 | −0.26 | 1.85 | 5.3 |
| Example 1 | | | | | | | | | | | |
| Comparative | 2 | 5.445 | 3.3 | 5.4 | 187.0 | 195.0 | 8.65 | 7.4 | −0.15 | 1.65 | 4.8 |
| Example 2 | | | | | | | | | | | |
| Example 1 | 3 | 6.825 | 3.5 | 6.8 | 151.0 | 172.0 | 8.6 | 7.54 | −0.05 | 1.95 | 2.4 |
| Example 2 | 4 | 7.02 | 3.6 | 7.0 | 151.0 | 172.0 | 8.61 | 7.53 | −0.05 | 1.95 | 2.4 |
| Example 8 | 4′ | 6.678 | 4.2 | 6.7 | 148 | 170 | 8.55 | 7.45 | −0.05 | 1.59 | 1.8 |
| Comparative | 5 | 6.65 | 3.5 | 6.8 | 151.0 | 172.0 | 8.6 | 7.54 | −0.07 | 1.95 | 4.5 |
| Example 3 | | | | | | | | | | | |
| Example 3 | 6 | 7.215 | 3.9 | 7.2 | 169.0 | 178.0 | 8.5 | 7.45 | −0.12 | 1.85 | 3.2 |
| Example 4 | 7 | 7.77 | 4.2 | 7.7 | 208.0 | 219.0 | 8.4 | 6.9 | −0.14 | 1.85 | 3.5 |
| Example 5 | 8 | 4.34 | 2.8 | 4.3 | 181.0 | 195.0 | 8.5 | 7.4 | −0.08 | 1.55 | 2.2 |
| Example 6 | 9 | 4.07 | 2.2 | 4.0 | 187.0 | 196.0 | 8.3 | 7.15 | −0.11 | 1.85 | 1.3 |
| Example 7 | 10 | 4.625 | 2.5 | 4.6 | 187.0 | 196.0 | 8.3 | 7.15 | −0.11 | 1.85 | 1.5 |
| Comparative | 11 | 8.25 | 5.0 | 8.2 | 230.0 | 236.0 | 8.4 | 7.2 | −0.18 | 1.65 | 4.5 |
| Example 4 | | | | | | | | | | | |
| Comparative | 12 | 4.352 | 3.2 | 4.3 | 151.0 | 172.0 | 8.5 | 7.45 | −0.05 | 1.36 | 4.2 |
| Example 5 | | | | | | | | | | | |
| Comparative | 13 | 1.875 | 1.5 | 1.9 | 95 | 120 | 7.6 | 7.2 | −0.015 | 1.25 | 15.0 |
| Example 6 | | | | | | | | | | | |

It is understood from the results shown in Tables 3 and 4 that the films of Examples, which have a thickness of from 20 to 60 μm, an Re (550) value of larger than 80 nm and equal to 350 nm or less and Em/Es of from 1.5 to 2.5 and satisfy the predetermined conditions for the storage modulus and the temperature, are optical films that have small optical unevenness and thus attain both a larger Re value and uniformity of the film. On the other hand, the films of Comparative Examples, which do not satisfy the requirements, have large optical unevenness with an increased Re value, or have a not large Re value with a decreased optical unevenness, and thus fail to attain both a larger Re value and uniformity of the film.

### Formation of Coated Layer

The surface of the film 4′ of Example 8 obtained above was subjected to a saponification treatment with a sodium hydroxide aqueous solution (saponification solution) having a NaOH concentration of 1.5 mol/L at 55° C. for 60 seconds, and rinsed with pure water at 25° C. for 60 seconds. After draining water with an air knife three times, the film was dried by placing in a drying zone at 70° C. for 15 seconds, thereby providing a saponified film. With respect to the saponified film, the following components were placed in a mixing tank and dissolved by stirring, thereby preparing a solution for an orientation layer.

| | | |
|---|---|---|
| P1 shown below (a/b/c = 96/2/2) | 100 | parts by mass |
| T1 shown below | 5 | parts by mass |
| Pure water (first solvent) | 3,150 | parts by mass |
| Methanol (second solvent) | 1,050 | parts by mass |

P1 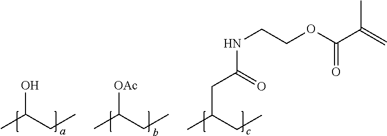
T1

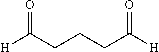

Thereafter, the composition for an orientation layer was coated on the saponified film with a wire bar #8 and dried at 110° C. for 60 seconds, thereby providing a film with an orientation layer.

Subsequently, the following components were placed in a mixing tank and dissolved by stirring under heating, thereby preparing a solution for a liquid crystal composition.

| | | |
|---|---|---|
| B1 shown below | 85 | parts by mass |
| B2 shown below | 15 | parts by mass |
| T02 shown below | 3 | parts by mass |
| Vertical orientation agent shown below | 1.3 | parts by mass |
| Surface conditioner shown below (a/b = 90/10) | 0.5 | parts by mass |
| Methyl ethyl ketone | 288 | parts by mass |
| Cyclohexanone | 32 | parts by mass |

B01 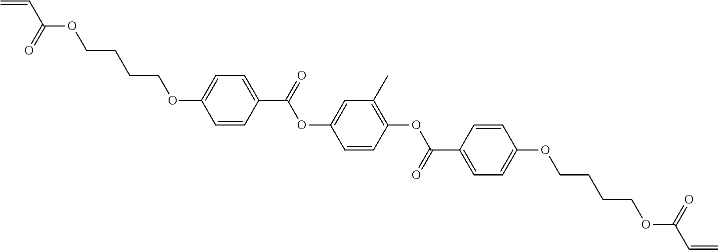 [SMILES: C=CC(=O)OCCCCOc1ccc(C(=O)Oc2ccc(OC(=O)c3ccc(OCCCCOC(=O)C=C)cc3)c(C)c2)cc1]
B02 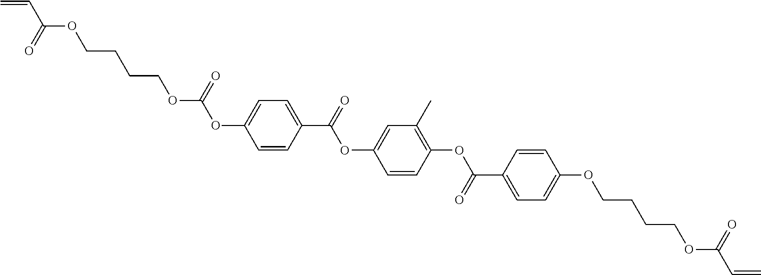 [SMILES: C=CC(=O)OCCCCOC(=O)Oc1ccc(C(=O)Oc2ccc(OC(=O)c3ccc(OCCCCOC(=O)C=C)cc3)c(C)c2)cc1]
T02 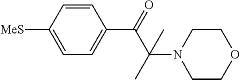 [SMILES: CSc1ccc(C(=O)C(C)(C)N2CCOCC2)cc1]
Vertical orientation agent 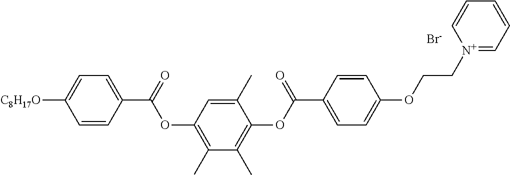
Surface conditioner

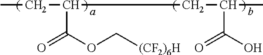

The solution for a liquid crystal composition was coated on the film with an orientation layer with a wire bar #3.2. The film was adhered to a metal flame and heated in a thermostat chamber at 60° C. for 90 seconds for orientation of the rod-like liquid crystal compound. Subsequently, the film was irradiated with an ultraviolet ray at 60° C. with a high pressure mercury lamp of 120 W/cm for 30 seconds for crosslinking the rod-like liquid crystal compound. Thereafter, the film was allowed to cool to room temperature.

Thus, a laminated film SF1 having a cellulose acylate film having thereon a coated layer formed of a homeotropic liquid crystal layer was produced.

### Production Example 4

### Production of IPS Mode Liquid Crystal Display Device

### Production of Polarizing Plate

### (1) Saponification of Film

The film 9 of Example and the laminated film SF1 were immersed in a sodium hydroxide aqueous solution (saponification solution) having a concentration of 1.5 mol/L at 55° C. for 2 minutes, then rinsed with water, then immersed in a sulfuric acid aqueous solution having a concentration of 0.05 mol/L for 30 seconds, and then immersed in a water bath. After draining water with an air knife three times, the film was dried by placing in a drying zone at 70° C. for 15 seconds, thereby providing a saponified film.

### (2) Production of Polarizing Film

The film was stretched in the machine direction with two pairs of nip rolls having a difference in circumferential velocity according to Example 1 of JP-A 2001-141926, which is expressly incorporated herein by reference in its entirety, thereby preparing a polarizing film having a thickness of 20 μm.

### (3) Adhesion

The film 9 having been subjected to the saponification treatment was adhered to one surface of the polarizing film thus obtained with a 3% PVA aqueous solution (PVA-117H, produced by Kuraray Co., Ltd.) as an adhesive, and the saponified surface of Fujitac (Fujitac T-40, produced by Fujifilm Corporation) was adhered to the other surface of the polarizing film, thereby producing a polarizing plate X1. The films were adhered in such a manner that the direction of the absorption axis of the polarizing film and the direction of the slow axis of the film were perpendicular to each other.

The laminated film SF1 having been subjected to the saponification treatment was adhered to one surface of the polarizing film thus obtained with a 3% PVA aqueous solution (PVA-117H, produced by Kuraray Co., Ltd.) as an adhesive, and the saponified surface of Fujitac (Fujitac T-40, produced by Fujifilm Corporation) was adhered to the other surface of the polarizing film, thereby producing a polarizing plate X2. The films were adhered in such a manner that the direction of the absorption axis of the polarizing film and the direction of the slow axis of the film were perpendicular to each other.

### Preparation of Liquid Crystal Cell

A liquid crystal panel was taken out from iPad 2 (produced by Apple, Inc.) equipped with an IPS mode liquid crystal cell. While the liquid crystal cell had optical films on the upper and lower side thereof, only the optical film on the upper side (front side) was removed, and then the front glass surface of the liquid crystal cell was cleaned.

### (5) Production of Liquid Crystal Display Device

The polarizing plate X1 was adhered to the display surface of the IPS mode liquid crystal cell. A commercially available cellulose triacetate film was adhered outside the liquid crystal cell. Thus, an IPS mode liquid crystal display device LCD-X1 was produced.

Separately, the polarizing plate X2 was adhered to the display surface of the IPS mode liquid crystal cell. A commercially available cellulose triacetate film was adhered outside the liquid crystal cell. Thus, an IPS mode liquid crystal display device LCD-X2 was produced.

### (6) Evaluation of Liquid Crystal Display Device

The produced LCD-X1 and LCD-X2 each displaying black color were observed from the front and from the oblique direction, and it was thus confirmed that ideal black color was displayed without leakage of light, and the color on viewing from the oblique direction was close to neutral.

The present disclosure relates to the subject matter contained in Japanese Patent Application No. 2012-086042, filed on Apr. 5, 2012, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film that:
has a thickness of from 20 to 60 μm;
has an in-plane retardation value Re (550) at a wavelength of 550 nm of larger than 80 nm and equal to 350 nm or less;
has an elastic modulus Em in a direction that is in parallel or perpendicular to one arbitrary edge of the film and provides a maximum elastic modulus of the film, and an elastic modulus Es in a direction that is perpendicular to the direction of Em, the elastic modulus Em and the elastic modulus Es satisfying the relationship Em/Es of from 1.5 to 2.5; and
satisfies a relationship shown by the following expression:
$$- 0.14 ≦ \frac{log {E}_{T 10}^{′} - log {E}_{T 100}^{′}}{{T}_{10} - {T}_{100}} ≦ - 0.02$$
wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

2. The optical film according to claim 1, wherein the optical film contains at least one kind of cellulose acylate having an acyl group containing an aromatic group at a total degree of substitution of from 0.1 to 2.0, an acyl group having an aliphatic group having from 2 to 4 carbon atoms at a total degree of substitution of from 2.0 to 2.6, or the both.

3. The optical film according to claim 1, wherein the total degree of substitution of the acyl group containing an aromatic group is from 0.5 to 1.2.

4. The optical film according to claim 1, wherein the total degree of substitution of the acyl group containing an aliphatic group having from 2 to 4 carbon atoms is from 2.2 to 2.55.

5. The optical film according to claim 1, wherein the optical film has an in-plane retardation value Re(550) at a wavelength of 550 nm of from 200 to 350 nm.

6. The optical film according to claim 1, wherein the optical film has a retardation value Rth(500) at a wavelength of 550 nm in a thickness direction of from −50 to 50 nm.

7. The optical film according to claim 1, wherein the optical film contains, as a major component, a cellulose substituted with an acyl group having an aromatic group, and the acyl group having an aromatic group is represented by the following general formula (I): 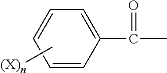
wherein X represents a hydrogen atom or a substituent; and n represents 0 or an integer of from 1 to 5, provided that when n is 2 or more, plural atoms or groups represented by X may be bonded to each other to form a condensed polycyclic ring.

8. The optical film according to claim 1, wherein the optical film contains, as a major component, a cellulose substituted with an acyl group having an aliphatic group, and the acyl group having an aliphatic group is an aliphatic acyl group having from 2 to 4 carbon atoms.

9. The optical film according to claim 8, wherein the optical film has a liquid crystal compound layer on the film containing, as a major component, the cellulose substituted with an acyl group having an aliphatic group having from 2 to 4 carbon atoms.

10. The optical film according to claim 2, wherein the cellulose acylate has one kind of the acyl group having an aromatic group and two kinds of the acyl groups having an aliphatic group.

11. The optical film according to claim 1, wherein the optical film further contains an ester oligomer.

12. The optical film according to claim 1, wherein the optical film further contains a sugar ester plasticizer.

13. The optical film according to claim 1, wherein the optical film has an Nz value of from 0.25 to 0.65.

14. The optical film according to claim 1, wherein the Em/Es is from 1.55 to 2.0.

15. A method for producing an optical film containing stretching a film at a ratio of from 50 to 120% at a stretching temperature in a range of Tg±20° C., wherein the optical film:
has a thickness of from 20 to 60 μm;
has an in-plane retardation value Re (550) at a wavelength of 550 nm of larger than 80 nm and equal to 350 nm or less;
has an elastic modulus Em in a direction that is in parallel or perpendicular to one arbitrary edge of the film and provides a maximum elastic modulus of the film, and an elastic modulus Es in a direction that is perpendicular to the direction of Em, the elastic modulus Em and the elastic modulus Es satisfying the relationship Em/Es of from 1.5 to 2.5; and
satisfies a relationship shown by the following expression:
$$- 0.14 ≦ \frac{log {E}_{T 10}^{′} - log {E}_{T 100}^{′}}{{T}_{10} - {T}_{100}} ≦ - 0.02$$
wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

16. The method for producing an optical film according to claim 15, wherein the stretching temperature is in a range of Tg±15° C.

17. The method for producing an optical film according to claim 15, which further contains heat-setting the stretched film at a temperature of from 150 to 250° C. for from 1 second to 3 minutes.

18. A polarizing plate containing a polarizing film and an optical film, wherein the optical film:
has a thickness of from 20 to 60 μm;
has an in-plane retardation value Re (550) at a wavelength of 550 nm of larger than 80 nm and equal to 350 nm or less;
has an elastic modulus Em in a direction that is in parallel or perpendicular to one arbitrary edge of the film and provides a maximum elastic modulus of the film, and an elastic modulus Es in a direction that is perpendicular to the direction of Em, the elastic modulus Em and the elastic modulus Es satisfying the relationship Em/Es of from 1.5 to 2.5; and
satisfies a relationship shown by the following expression:
$$- 0.14 ≦ \frac{log {E}_{T 10}^{′} - log {E}_{T 100}^{′}}{{T}_{10} - {T}_{100}} ≦ - 0.02$$
wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

19. A liquid crystal display device containing a polarizing plate containing a polarizing film and an optical film, wherein the optical film:
has a thickness of from 20 to 60 μm;
has an in-plane retardation value Re (550) at a wavelength of 550 nm of larger than 80 nm and equal to 350 nm or less;
has an elastic modulus Em in a direction that is in parallel or perpendicular to one arbitrary edge of the film and provides a maximum elastic modulus of the film, and an elastic modulus Es in a direction that is perpendicular to the direction of Em, the elastic modulus Em and the elastic modulus Es satisfying the relationship Em/Es of from 1.5 to 2.5; and
satisfies a relationship shown by the following expression:
$$- 0.14 ≦ \frac{log {E}_{T 10}^{′} - log {E}_{T 100}^{′}}{{T}_{10} - {T}_{100}} ≦ - 0.02$$
wherein T₁₀ represents a temperature where E′RT becomes 1/10; T₁₀₀ represents a temperature where E′RT becomes 1/100; log E′_{T10} represents log E′ where E′RT becomes 1/10; and log E′_{T100} represents log E′ where E′RT becomes 1/100, wherein E′ represents a storage modulus of the film measured by dynamic viscoelastic measurement, and E′RT represents the storage modulus of the film at room temperature.

20. The liquid crystal display device according to claim 19, wherein the liquid crystal display device is an IPS type.
